(19) United States
(12) Patent Application Publication
(10) Pub. No.: US 2008/0235745 A1
(43) Pub. Date: Sep. 25, 2008

(54) System and method to provide video communication with a service provider

(75) Inventors: Gregory Edwards, Austin, TX (US); Javier Arellano, Austin, TX (US); Donald Garofalo, Austin, TX (US); Paul Van Vleck, Austin, TX (US); Marc A. Sullivan, Austin, TX (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/728,210

(22) Filed: Mar. 23, 2007

(51) Int. Cl. H04N 7/173; G06F 3/00

(52) U.S. Cl. 725/110; 715/700

(57) ABSTRACT

Methods and systems for providing a video link are provided. A method may include receiving a request to establish a first video link to a healthcare service provider. The method may also include selecting a first healthcare service provider from at least two healthcare service providers and establishing the first video link to the first healthcare service provider.

### FIELD OF THE DISCLOSURE

The present disclosure is generally related to providing video communication with a service provider.

### BACKGROUND

Telephone communication is a popular medium to exchange information with a service provider, such as an emergency service provider. However, certain limitations exist when using a telephone to exchange information. For example, when a caller is using a telephone, the service provider typically cannot visually inspect an item or circumstance that the caller is describing. Similarly, the caller may misconstrue instructions or other verbal statements provided by the service provider. Thus, an improved system and method to provide video communication with a service provider is needed.

### BRIEF DESCRIPTION OF THE DRAWINGS

FIG. 1 is a block diagram of a first illustrative embodiment of a system to provide video communication with a service provider;

FIG. 2 is a block diagram of a second illustrative embodiment of a system to provide video communication with a service provider;

FIG. 3 is a flow chart of a first illustrative embodiment of a method of providing video communication with a service provider;

FIG. 4 is a diagram of a first particular illustrative embodiment of a graphical user interface to provide video communication with a service provider;

FIG. 5 is a diagram of a second particular illustrative embodiment of a graphical user interface to provide video communication with a service provider;

FIG. 6 is a block diagram of an illustrative embodiment of an Internet Protocol Television (IPTV) system that may be used to provide video communication with a service provider; and

FIG. 7 is a block diagram of an illustrative embodiment of a general computer system.

### DETAILED DESCRIPTION OF THE DRAWINGS

The disclosure is directed to systems and methods of providing a video link. In a particular embodiment, a method may include receiving a request via a network to establish a first video link between a request location and a first service provider. The method may also include selecting the first service provider from at least two service providers. The method may also include establishing the first video link over the network.

In a particular embodiment, a device is disclosed that includes a network interface and a processor coupled to the network interface. The processor may be operable to execute a method including receiving a request to establish a first video link between the device and a first service provider. The method may also include transmitting information to provide for a selection of a first service provider from at least two service providers, the selection at least partially based on the information. The method may also include establishing the first video link via the network interface with the first. The method may also include providing a first video received over the first video link to a display device.

In a particular embodiment, a graphical user interface is disclosed that includes a first screen comprising a channel listing including a first channel to display at least one video received from a service provider. The graphical user interface may also include a first selectable element, wherein a selection of the first selectable element initiates a request to establish a first video link with a first service provider to provide a first video on the first channel.

In a particular embodiment, a computer-readable medium is disclosed that includes instructions to cause a processor to perform a method. The method may include receiving a request to establish a video connection to a service provider. The method may also include initiating the video connection to the service provider based on the request.

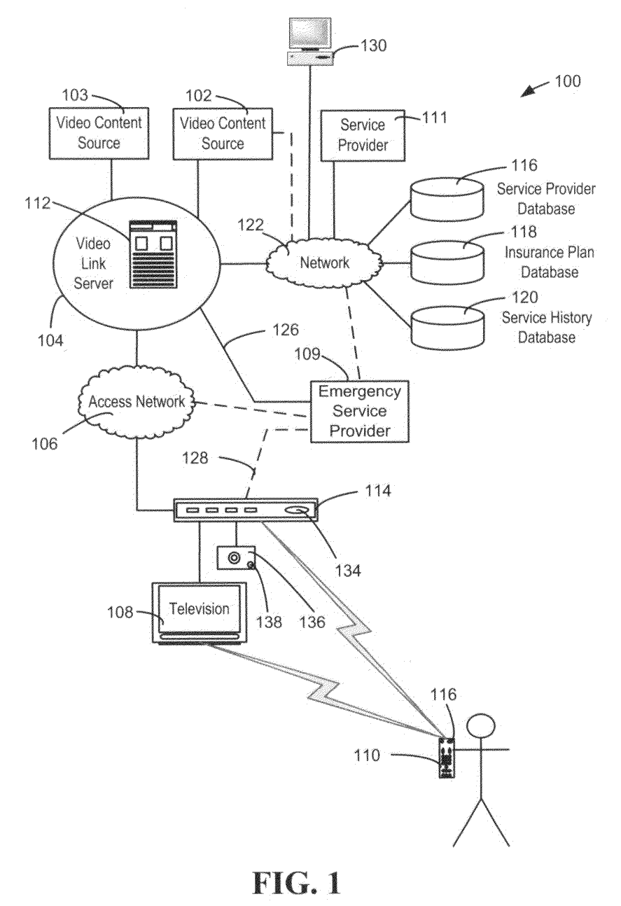

Referring to FIG. 1, a particular embodiment of a system to provide video communication with a service provider is illustrated and generally designated 100. The system 100 includes a first video content source 102 and a second video content source 103 that provide video content to a user device 114. The video content source 102 and the video content source 103 may be associated with any video content provider and may include live video transmissions, television programs, instructional videos, or any combination thereof. In a particular embodiment, the video content sources 102,103 can send the video content to a hub office 104, such as a national a hub office, a regional hub office, or local hub office, which communicates with the user device 114 via an access network 106. In a particular embodiment, the video content sources 102, 103 may provide the video content to the hub office 104 directly or through a communication network 122. In another embodiment, the hub office 104 may include one or more of the video content sources 102,103.

In a particular embodiment, the hub office 104 may include a video link server 112 to facilitate video communication between the user device 114, or a device coupled thereto, and one or more service providers, such as the emergency service provider 109 or another service provider 111. For purposes of description, the video link server 112 is described as one server; however, in certain embodiments, the video link server 112 may include a plurality of servers that independently or redundantly provide one or more functions related to providing video communication. The hub office 104 may communicate with a first service provider 109 and a second service provider 111. The hub office 104 may communicate with the first service provider 109 through a first direct communication link 126, through the communication network 122, or through the access network 106. In a particular embodiment, the user device 114 may be in communication with the first service provider 109 through a second direct communication link 128.

In a particular embodiment, the first service provider 109 and the second service provider 111 may include a healthcare service provider, an emergency service provider, an ambulance service provider, a police service provider, a security service provider, a first responder service provider, a security service provider, a fire service provider, an emergency room service provider, a live operator service provider, a 9-1-1 service provider, a poison first aid service provider, an electrical service provider, a gas service provider, a plumbing service provider, or any combination thereof.

Further, the video link server 112 may communicate with a service provider database 116, an insurance plan database 118, a service history database 120, or any combination thereof, via the network 122. In a particular embodiment, the communication network 122 may be an intranet communication network, an extranet communication network, a cellular communication network, the Internet, or another type of communication network.

In a particular embodiment, the service provider database 116 may include information related to service providers. The information related to service providers may include an availability of a service provider, a specialty of a service provider, a location of a service provider, contact information for a service provider, a quality rating of a service provider, or any combination thereof.

In a particular embodiment, the service provider database 116 may include information related to healthcare service providers. The information related to healthcare service providers may include an availability of a healthcare service provider, a specialty of a healthcare service provider, a specialty of a specific person at a healthcare service provider, a location of a healthcare service provider, a proximity of a healthcare service provider, contact information for a healthcare service provider, a quality rating of a healthcare service provider, or any combination thereof.

In a particular embodiment, the insurance plan database 118 may include information related to insurance plans. The information related to insurance plans may include an insurance plan identification, a co-pay amount, a deductible amount, an eligible service provider, contact information, a coverage type, a maximum coverage amount, a policy holder, a person covered under the policy, or any combination thereof.

In a particular embodiment, the service history database 120 may include information related to a history of a service provider. The information related to the history of the service provider may include information related to a past service, a previous service date, a future service date, an equipment identification, a specific service technician, or any combination thereof.

In a particular embodiment, the service history database 120 may include information related to a medical history of a person. The information related to the medical history may include information for a patient including allergy information, treatment information, medication information, payment information, diagnosis information, or any combination thereof.

In a particular embodiment, the service provider database 116, the insurance plan database 118, and the service history database 120 may be updated via the hub office 104 or via a computing device 130 connected through the communication network 122. In a particular embodiment, the service provider database 116, the insurance plan database 118, the service history database 120, or any combination thereof, may be updated by a user of a service provider or by the service provider. In another particular embodiment, the service provider database 116, the insurance plan database 118, the service history database 120, or any combination thereof, may be updated via a website.

The user device 114 may be coupled to or integrated with a display device 108, such as a television monitor. In addition, the user device 114 may be coupled to or integrated with a video capture device 136. The video capture device 136 may include a microphone 138. The user device 114 may communicate with a remote control device 110. The user device 114 may include a selection key 116. The user device 114 may include an Internet Protocol Television (IPTV) set-top box device; a video gaming device or a console that is adapted to receive IPTV content; an interface device within the display device 108, such as a cable card; a personal computer or other computing devices that is adapted to emulate set-top box device functionalities; any other device adapted to receive video content and transmit data to a server via the access network 106; or any combination thereof.

In a particular illustrative embodiment, the video link server 112 may receive a request from the user device 114 via the access network 106 to establish video communication, such as a first video link, with a service provider. The video link server 112 may select a first service provider 109 from at least two service providers identified in the service provider database 116. The video link server 112 may establish the first video link to the first service provider over the communication network 122 and to the user device 114 over the access network 106. In a particular embodiment, the first video link can be a two-way video link between the user device 114 and the first service provider 109. The video link server 112 may receive a first live video stream from the user device 114 and transmit the first live video stream to the first service provider 109. Further, the video link server 112 may receive a first video from the first service provider 109. Alternatively, the first service provider 109 may provide the first video to the first video content source 102, and the video link server 112 can retrieve the first video from the first video content source 102 in response to the request from the user device 114. The video link server 112 may transmit the first video to the user device 114 via the access network 106.

In one example, the first service provider 109 can be a healthcare service provider, such as an emergency service provider. The video link server 112 can receive a request from the user device 114 to establish two-way video communication with the emergency service provider. The video link server 112 can receive a live video feed from the user device 114, where the live video feed includes video of an emergency. In a particular embodiment, the video link server 112 may receive an instructional video, such as a cardio-pulmonary resuscitation (CPR) via the first video link from the first service provider 109 and transmit the instructional video to the user device 114 via the first video link.

In another particular embodiment, the video link server 112 may establish a second video link while maintaining the first video link. For example, the second video link may facilitate video communication between the second service provider 111 and the user device 114. The video link server may receive a second video from the second service provider 111 via the second video link. In a particular embodiment, the video link server 112 can receive the second video from the second service provider 111. In another particular embodiment, the second service provider 111 may provide the second video to the second video content source 103, and the video link server 112 can retrieve the second video from the second content source 103 in response to a request from the user device 114.

In a particular embodiment, the video link server 112 may receive a first live video stream over the first video link from the first service provider 109 and transmit the first live video stream to the user device 114. The video link server 112 may receive video content associated with the second service provider 111, such as an instructional video, and transmit the instructional video to the user device 114 while maintaining the first live video stream. In a particular embodiment, the second video may be from the second service provider 111 or may be from another video content source, such as the first video content source 102 or the second video content source 103.

In a particular embodiment, the video link server 112 may receive data from the user device 114, the service provider database 116, the insurance plan database 118, or the service history database 120. The video link server 112 may select a service provider at least partially based on the data. The data may include data related to a service provider, an insurance plan, a medical history, a proximity of a service provider, an availability of a service provider, a specialty of a service provider, a location of a service provider, contact information for a service provider, a quality rating of a service provider, an insurance plan identification, a co-pay amount, a deductible amount, an eligible service provider, a coverage type, a maximum coverage amount, a policy holder, a person covered under the policy, a past service, a previous service date, a future service date, an equipment identification, a specific service technician, allergy information, a medical treatment information, a medication information, a payment information, a problem diagnosis information, or any combination thereof.

For example, the video link server 112 can receive data from the user device 114 indicating a request to communicate with a healthcare service provider other than an emergency service. The video link server 112 may query the service history database 120 for an identification of a healthcare service provider associated with the user device 114. The video link server 112 can retrieve contact information or other information related to the a healthcare service provider from the service provider database 116, based on data received from the service history database 120, and the video link server 112 can establish video communication with the healthcare service provider using the contact information.

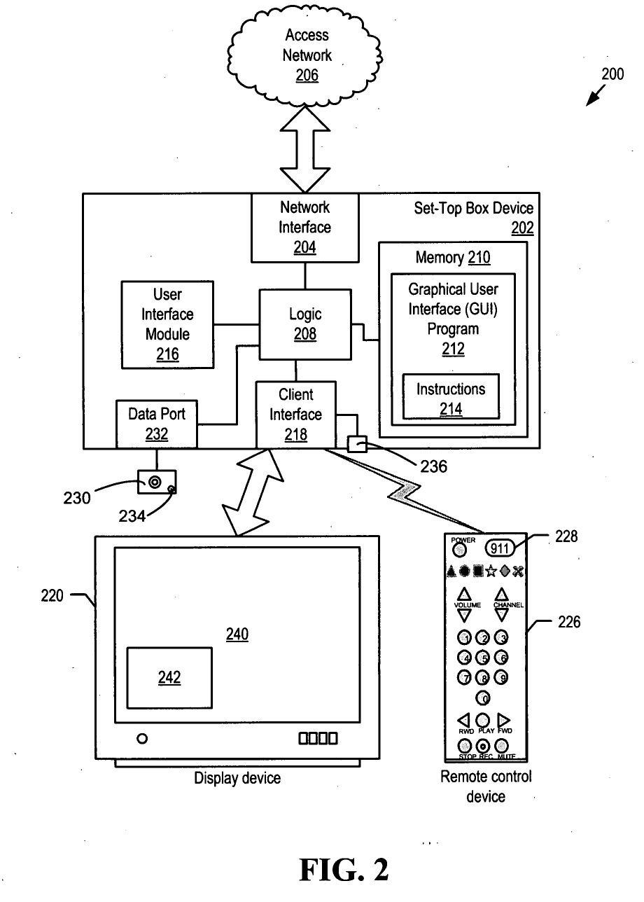

FIG. 2 depicts a block diagram of a second illustrative embodiment of a system to provide a video link, the system designated 200. The system 200 includes a user device, such as a set-top box device 202, communicating with an access network 206 of a video distribution system, such as an Internet Protocol Television (IPTV) system. The set-top box device 202 includes logic 208 and memory 210 accessible to the logic 208. In a particular embodiment, the logic 208 may be a processor or controller. The logic 208 can be coupled to a network interface 204 that facilitates communication between the set-top box device 202 and the access network 206. Further, the set-top box device 202 can communicate with a display device 220 and a remote control device 236 via a client interface 218. Additionally, the set-top box device 202 can communicate with a video capture device 230 via a data port 232.

In a particular embodiment, the memory 210 may include instructions 214, executable by the logic 208 to provide a graphical user interface (GUI) to establish video communication with a service provider at the display device 220. In an illustrative embodiment, the instructions 214 can be a portion of a GUI software application or other computer program stored at the memory 210. The GUI provided at the display device 218 may allow for establishing a video link to a service provider, such as a healthcare service provider or an emergency service provider. One or more data streams corresponding to the video link can be received via from the access network 206 the network interface 204. The data stream(s) received via the access network 206 may include a live video transmission, a recorded video transmission, or any combination thereof.

In an illustrative embodiment, multiple video links can be established via the GUI, and multiple video data streams can be received via the network interface 204. For example, a first video data stream including a live video stream from a first service provider may be received at the set-top box device 202. The set-top box device 202 can send the live video stream to the display device 220 to be displayed in a first GUI region 240. Moreover, a second video data stream including an instructional video data stream from a second service provider may be received at the set-top box device 202. The set-top box device 202 can send the live video stream to the display device 220 to be displayed in a first GUI region 242, such as a picture-in-picture viewing area. In another particular embodiment, the first portion 240 and the second portion 242 can form a side-by-side view.

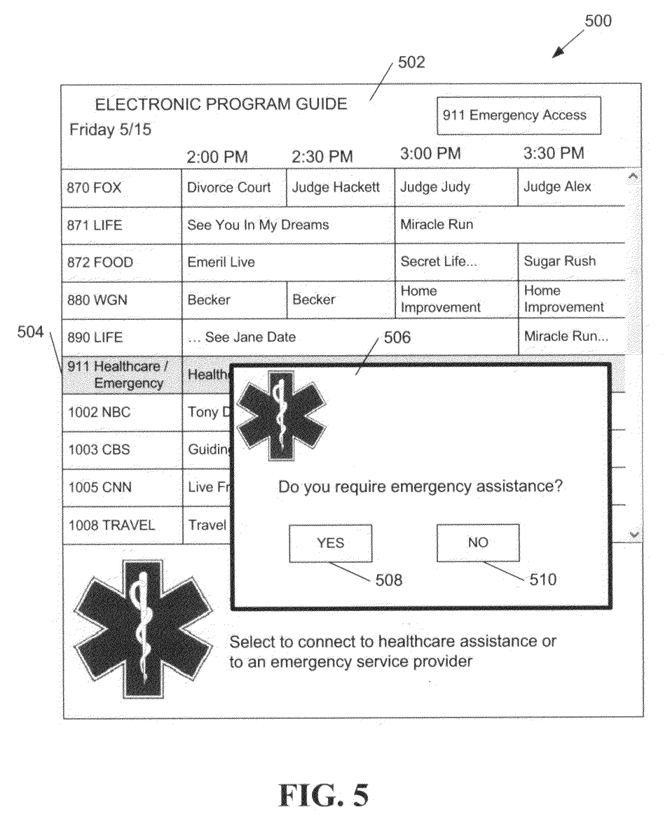

The set-top box device 202 may receive user input from a remote control device 226 and process the user input via the user interface module 216. In response to the user input, the logic 208 may modify the graphical user interface 212. In a particular embodiment, the graphical user interface 212 may present a data input request to the user. For example, the data input request may include selectable indicators of options, such as those illustrated in FIG. 5. In another particular embodiment, the data input request may include a text field to be filled in or confirmed by the user.

In a particular embodiment, the user may select at least one selectable element of the graphical user interface 212 using the remote control device 226. In an illustrative embodiment, the user may select a user selectable element by navigating a selection mechanism, such as a highlight mechanism, on the screen until the desired selectable element is selected, and confirming the selection. In another illustrative embodiment, the user may select the user selectable element by entering a value on a keypad of the remote control device 226. In still another illustrative embodiment, the user may select the user selectable element by using a hot key 228 on the remote control device 226 that is associated with the selected element. In yet another illustrative embodiment, the user may select the user selectable element by using a selection key 236 on the set-top box device 202. In a particular embodiment, the selection key 236 may be a dedicated key to initiate a video and/or audio communication with a service provider.

In a particular embodiment, a user may select a user selectable element of the graphical user interface 212 to initiate a video link with a service provider through the communication network 206. In a particular embodiment, the video link is a two-way video link in which video and/or audio may be transmitted from the user location to a service provider and video and/or audio may be received from a service provider. The client interface 218 may receive an indication of the selection, and the logic 208 may transmit the selection via the access network 206 to a server. The server may establish a first video link with the set-top box device 202 via the access network 206, and the logic 208 may provide video content received from the service provider to the display device 220 via the client interface 218.

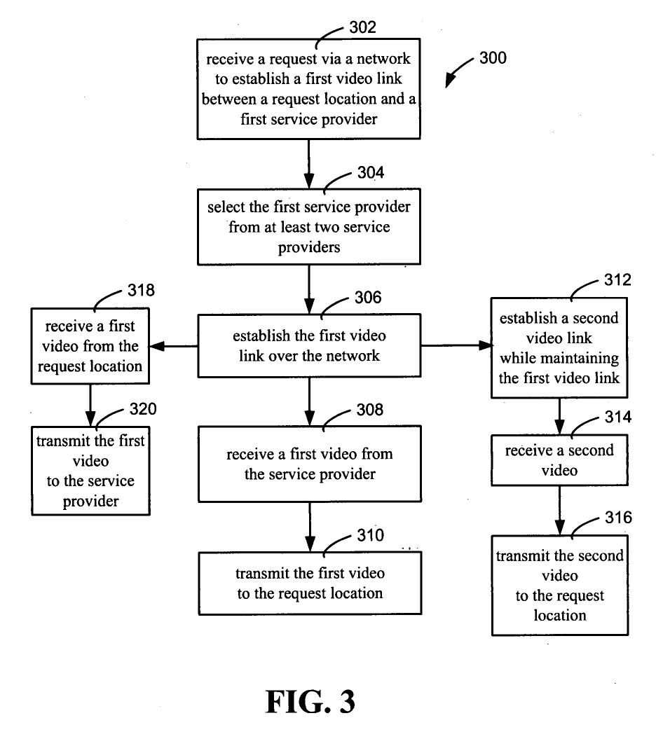

FIG. 3 depicts a flow chart of a first illustrative embodiment of a method of providing a video link, designated 300. The method 300 includes, at 302, receiving a request via a network to establish a first video link between a request location and a first service provider. In a particular embodiment, the request may be initiated by a user device, such as the user device 114 illustrated in FIG. 1. In a particular embodiment, the request location may be identified by an addressable user device. In a particular embodiment, the service provider is a healthcare service provider. In another particular embodiment, the service provider is an emergency service provider. In still another particular embodiment, the service provider is an instructional video service provider.

In a particular embodiment, the method 300 also includes selecting the first service provider from at least two service providers, at 304. In a particular embodiment, data may be received and a service provider may be selected at least partially based on the data. The data may include data related to a service provider, an insurance plan, a service provider history, or any combination thereof.

In a particular embodiment, the method 300 also includes establishing the first video link over the network, at 306. In a particular embodiment, the first video link is a two-way video link between the user device and the first service provider.

In a particular embodiment, the method 300 may also include receiving a first video from the first service provider, at 308, and transmitting the first video to the request location, at 310. In a particular embodiment, the request location may be identified by an identification of a user device, such as user the device 114 or the set-top-box 202 illustrated in FIGS. 1 and 2, respectively. In a particular embodiment, the first video may be an instructional video. In another particular embodiment, the first video may be a live video transmission.

In a particular embodiment, a first live video stream from the request location may be received, at 318. In another particular embodiment, the first live video stream may be received from a user device, such as the user device 114, and the live video stream may be captured by a video capture device, such as the video capture device 136 illustrated in FIG. 1. In still another particular embodiment, the first live video stream may be transmitted to the first service provider, at 320. In another particular embodiment, an audio stream may also be transmitted with the first live video stream. In still another particular embodiment, the audio stream may or may not be associated with the first live video stream. In yet still another particular embodiment, only an audio stream may be provided to the first service provider.

In a particular embodiment, a second video link may be established while maintaining the first video link, at 312. In another particular embodiment, a second video may be received, at 314. In another particular embodiment, the second video may be transmitted to the request location, at 316. In yet another particular embodiment, the second video may be transmitted to the request location to be viewed concurrently as the first video. In still another particular embodiment, the second video link may be established with the first service provider. In still yet another particular embodiment, the second video link may be established with a second service provider. In another particular embodiment, the second video link may be established with a video content source.

In a particular embodiment, a first live video stream may be received over the first video link from the first service provider and then transmitted over the first video link to the request location. In a particular embodiment, an audio stream may also be transmitted over the first video link. In still another particular embodiment, the audio stream may or may not be associated with the first live video stream.

In another particular embodiment, a second video stream may be received and then transmitted to the request location while maintaining the first live video stream. In another particular embodiment, the second video stream may be from the service provider. In still another particular embodiment, the second video stream may be from another video content source, such as a second service provider. In another particular embodiment, the first live video stream may include a video transmission of a live person. In still another particular embodiment, the second video stream may be an instructional video. In still yet another particular embodiment, the second video stream may be saved to a storage device of a user device, such as the user device 114, to allow playback at a later time. In yet another particular embodiment, the second video stream may be played back from the storage device when a first video stream may also be viewed.

In a particular embodiment, a video transmission may be provided from or received at a portable video device. A portable video device can include a cellular phone, a personal digital assistant (PDA), a mobile computer, or a video camera. The video transmission may include recorded videos or a live video stream. For example, the service provider may provide a video transmission via a portable video device from an ambulance to the request location. In another example, a video transmission may be provided from the request location to an ambulance.

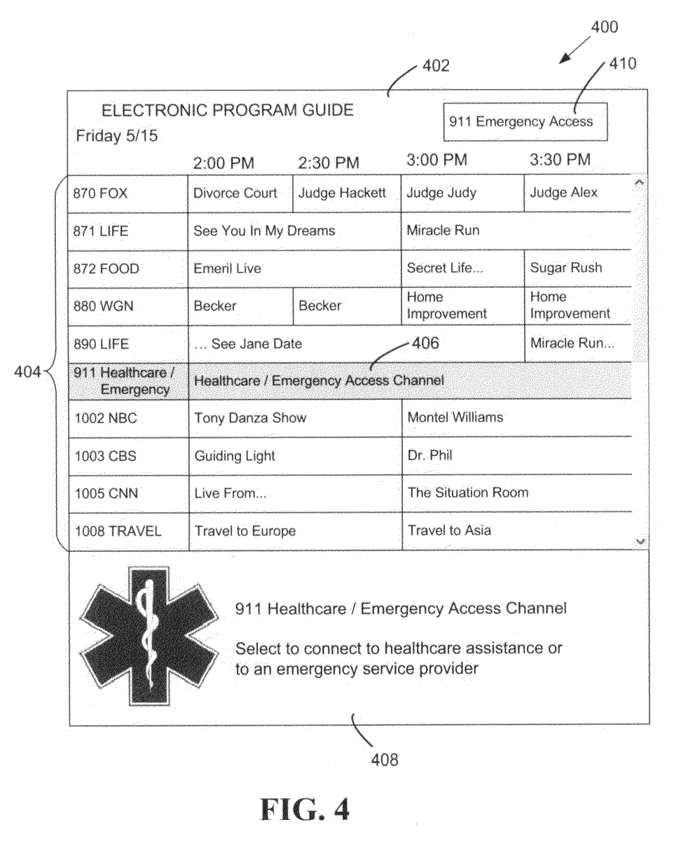

FIG. 4 is a diagram of a first particular illustrative embodiment of a graphical user interface 400 to provide a video link. The graphical user interface (GUI) 400 includes an electronic program guide 402 that may include a list 404 of available selections. In a particular embodiment, the available selections are channels for viewing a video.

In a particular embodiment, the electronic program guide 402 may include a first selectable element 410 to initiate a request to make a video link with a service provider. In a particular embodiment, the service provider may be a healthcare service provider, an emergency service provider, or an instructional service provider. In yet another particular embodiment, the service provider is a 9-1-1 service provider.

In a particular embodiment, the electronic program guide 402 may include a second selectable element 406 to initiate a request to make a video link with a service provider. In a particular embodiment, the selectable element 406 may include a channel listing. In another particular embodiment, more than one channel may be provided to select at least one service provider. In yet another particular embodiment, more than one channel may be provided to select more than one service provider. In a particular embodiment, the electronic program guide 402 may have both the first selectable element 410 and the second selectable element 406.

In a particular embodiment, a selection of at least one of the selectable elements of the electronic program guide 402 may be made from a remote control device. In another particular embodiment, a user may select a selectable element by navigating a selection mechanism, such as a highlight mechanism, on the screen until the desired selectable element is selected, and confirming the selection. In a particular embodiment, a description 408 of a highlighted selectable element may be displayed. In another particular embodiment, the second selectable element 406 may be assigned channel number nine hundred eleven (911).

FIG. 5 is a diagram of a second particular illustrative embodiment of a graphical user interface 500 to provide a video link. The graphical user interface (GUI) 500 includes an electronic program guide 502.

In a particular illustrative embodiment, a user may select a first selectable element 504 of the electronic program guide 502 to initiate a request to provide a video link to a service provider. In a particular embodiment, the service provider may be a healthcare service provider, an emergency service provider, or an instructional service provider. In yet another particular embodiment, the service provider is a 9-1-1 service provider.

In a particular embodiment, when the first selectable element 504 is selected, a verification screen 506 may be presented. In a particular embodiment, the verification screen 506 may include a second selectable element 508 to confirm the request to initiate a video link to the service provider. In another particular embodiment, the verification screen may include a third selectable element 510 to cancel the request to initiate a video link to the service provider. In yet another particular embodiment, a personal identification number (PIN) entry may be provided to execute the request to initiate a video link with the service provider. In still another embodiment, a text form may be presented to allow data to be entered to be sent to the service provider.

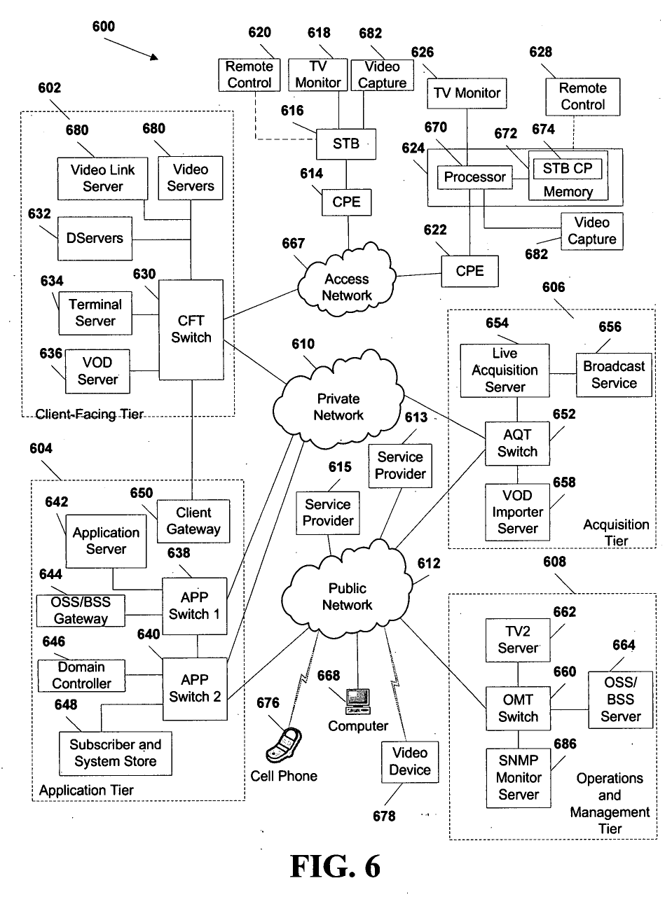

Referring to FIG. 6, an illustrative embodiment of an Internet Protocol Television (IPTV) system that may be used to provide a set-top box application is illustrated and is generally designated 600. As shown, the system 600 can include a client facing tier 602, an application tier 604, an acquisition tier 606, and an operations and management tier 608. Each tier 602, 604, 606, 608 is coupled to a private network 610; to a public network 612, such as the Internet; or to both the private network 610 and the public network 612. For example, the client-facing tier 602 can be coupled to the private network 610. Further, the application tier 604 can be coupled to the private network 610 and to the public network 612. The acquisition tier 606 can also be coupled to the private network 610 and to the public network 612. Additionally, the operations and management tier 608 can be coupled to the public network 612.

As illustrated in FIG. 6, the various tiers 602, 604, 606, 608 communicate with each other via the private network 610 and the public network 612. For instance, the client-facing tier 602 can communicate with the application tier 604 and the acquisition tier 606 via the private network 610. The application tier 604 can communicate with the acquisition tier 606 via the private network 610. Further, the application tier 604 can communicate with the acquisition tier 606 and the operations and management tier 608 via the public network 612. Moreover, the acquisition tier 606 can communicate with the operations and management tier 608 via the public network 612. In a particular embodiment, elements of the application tier 604, including, but not limited to, a client gateway 650, can communicate directly with the client-facing tier 602.

The client-facing tier 602 can communicate with user equipment via an access network 667, such as an Internet Protocol Television (IPTV) access network. In an illustrative embodiment, customer premises equipment (CPE) 614, 622 can be coupled to a local switch, router, or other device of the access network 667. The client-facing tier 602 can communicate with a first representative set-top box device 616 via the first CPE 614 and with a second representative set-top box device 624 via the second CPE 622. In a particular embodiment, the first representative set-top box device 616 and the first CPE 614 can be located at a first customer premise, and the second representative set-top box device 624 and the second CPE 622 can be located at a second customer premise. In another particular embodiment, the first representative set-top box device 616 and the second representative set-top box device 624 can be located at a single customer premise, both coupled to one of the CPE 614, 622. The CPE 614, 622 can include routers, local area network devices, modems, such as digital subscriber line (DSL) modems, any other suitable devices for facilitating communication between a set-top box device and the access network 667, or any combination thereof.

In an exemplary embodiment, the client-facing tier 602 can be coupled to the CPE 614, 622 via fiber optic cables. In another exemplary embodiment, the CPE 614, 622 can be digital subscriber line (DSL) modems that are coupled to one or more network nodes via twisted pairs, and the client-facing tier 602 can be coupled to the network nodes via fiber-optic cables. Each set-top box device 616, 624 can process data received via the access network 667, via an IPTV software platform, such as Microsoft® TV IPTV Edition.

The first set-top box device 616 can be coupled to a first external display device, such as a first television monitor 618, and the second set-top box device 624 can be coupled to a second external display device, such as a second television monitor 626. Moreover, the first set-top box device 616 can communicate with a first remote control 620, and the second set-top box device 624 can communicate with a second remote control 628. The set-top box devices 616, 624 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof. The first set-top box device and the second set-top box device can be coupled to video capture devices 682 to receive video and/or audio signals.

In an exemplary, non-limiting embodiment, each set-top box device 616, 624 can receive data, video, or any combination thereof, from the client-facing tier 602 via the access network 667 and render or display the data, video, or any combination thereof, at the display device 618, 626 to which it is coupled. In an illustrative embodiment, the set-top box devices 616, 624 can include tuners that receive and decode television programming signals or packet streams for transmission to the display devices 618, 626. Further, the set-top box devices 616, 624 can include a STB processor 670 and a STB memory device 672 that is accessible to the STB processor 670. In one embodiment, a computer program, such as the STB computer program 674, can be embedded within the STB memory device 672.

In an illustrative embodiment, the client-facing tier 602 can include a client-facing tier (CFT) switch 630 that manages communication between the client-facing tier 602 and the access network 667 and between the client-facing tier 602 and the private network 610. As illustrated, the CFT switch 630 is coupled to one or more data servers, such as D-servers 632, that store, format, encode, replicate, or otherwise manipulate or prepare video content for communication from the client-facing tier 602 to the set-top box devices 616, 624. The CFT switch 630 can also be coupled to a terminal server 634 that provides terminal devices with a point of connection to the IPTV system 600 via the client-facing tier 602. In a particular embodiment, the CFT switch 630 can be coupled to a video-on-demand (VOD) server 636 that stores or provides VOD content imported by the IPTV system 600. Further, the CFT switch 630 is coupled to one or more video servers 680 that receive video content and transmit the content to the set-top boxes 616, 624 via the access network 667.

In an illustrative embodiment, the client-facing tier 602 can communicate with a large number of set-top boxes, such as the representative set-top boxes 616, 624, over a wide geographic area, such as a metropolitan area, a viewing area, a statewide area, a regional area, a nationwide area or any other suitable geographic area, market area, or subscriber or customer group that can be supported by networking the client-facing tier 602 to numerous set-top box devices. In a particular embodiment, the CFT switch 630, or any portion thereof, can include a multicast router or switch that communicates with multiple set-top box devices via a multicast-enabled network.

As illustrated in FIG. 6, the application tier 604 can communicate with both the private network 610 and the public network 612. The application tier 604 can include a first application tier (APP) switch 638 and a second APP switch 640. In a particular embodiment, the first APP switch 638 can be coupled to the second APP switch 640. The first APP switch 638 can be coupled to an application server 642 and to an OSS/BSS gateway 644. In a particular embodiment, the application server 642 can provide applications to the set-top box devices 616, 624 via the access network 667, which enable the set-top box devices 616, 624 to provide functions, such as interactive program guides, video gaming, display, messaging, processing of VOD material and other IPTV content, etc. In an illustrative embodiment, the application server 642 can provide location information to the set-top box devices 616, 624. In a particular embodiment, the OSS/BSS gateway 644 includes operation systems and support (OSS) data, as well as billing systems and support (BSS) data. In one embodiment, the OSS/BSS gateway 644 can provide or restrict access to an OSS/BSS server 664 that stores operations and billing systems data.

The second APP switch 640 can be coupled to a domain controller 646 that provides Internet access, for example, to users at their computers 668, their cell phones 676, or their video devices 678 via the public network 612. For example, the domain controller 646 can provide remote Internet access to IPTV account information, e-mail, personalized Internet services, or other online services via the public network 612. In addition, the second APP switch 640 can be coupled to a subscriber and system store 648 that includes account information, such as account information that is associated with users who access the IPTV system 600 via the private network 610 or the public network 612. In an illustrative embodiment, the subscriber and system store 648 can store subscriber or customer data and create subscriber or customer profiles that are associated with IP addresses, stock-keeping unit (SKU) numbers, other identifiers, or any combination thereof, of corresponding set-top box devices 616, 624. In another illustrative embodiment, the subscriber and system store can store data associated with capabilities of set-top box devices associated with particular customers.

In a particular embodiment, the application tier 604 can include a client gateway 650 that communicates data directly to the client-facing tier 602. In this embodiment, the client gateway 650 can be coupled directly to the CFT switch 630. The client gateway 650 can provide user access to the private network 610 and the tiers coupled thereto. In an illustrative embodiment, the set-top box devices 616, 624 can access the IPTV system 600 via the access network 667, using information received from the client gateway 650. User devices can access the client gateway 650 via the access network 667, and the client gateway 650 can allow such devices to access the private network 610 once the devices are authenticated or verified. Similarly, the client gateway 650 can prevent unauthorized devices, such as hacker computers or stolen set-top box devices from accessing the private network 610, by denying access to these devices beyond the access network 667.

For example, when the first representative set-top box device 616 accesses the client-facing tier 602 via the access network 667, the client gateway 650 can verify subscriber information by communicating with the subscriber and system store 648 via the private network 610. Further, the client gateway 650 can verify billing information and status by communicating with the OSS/BSS gateway 644 via the private network 610. In one embodiment, the OSS/BSS gateway 644 can transmit a query via the public network 612 to the OSS/BSS server 664. After the client gateway 650 confirms subscriber and/or billing information, the client gateway 650 can allow the set-top box device 616 to access IPTV content and VOD content at the client-facing tier 602. If the client gateway 650 cannot verify subscriber information for the set-top box device 616, e.g., because it is connected to an unauthorized twisted pair, the client gateway 650 can block transmissions to and from the set-top box device 616 beyond the access network 667.

As indicated in FIG. 6, the acquisition tier 606 includes an acquisition tier (AQT) switch 652 that communicates with the private network 610. The AQT switch 652 can also communicate with the operations and management tier 608 via the public network 612. In a particular embodiment, the AQT switch 652 can be coupled to a live acquisition server 654 that receives or acquires television content, movie content, advertisement content, other video content, or any combination thereof, from a broadcast service 656, such as a satellite acquisition system or satellite head-end office. In a particular embodiment, the live acquisition server 654 can transmit content to the AQT switch 652, and the AQT switch 652 can transmit the content to the CFT switch 630 via the private network 610.

In an illustrative embodiment, content can be transmitted to the D-servers 632, where it can be encoded, formatted, stored, replicated, or otherwise manipulated and prepared for communication from the video server(s) 680 to the set-top box devices 616, 624. The CFT switch 630 can receive content from the video server(s) 680 and communicate the content to the CPE 614, 622 via the access network 667. The set-top box devices 616, 624 can receive the content via the CPE 614, 622, and can transmit the content to the television monitors 618, 626. In an illustrative embodiment, video or audio portions of the content can be streamed to the set-top box devices 616, 624.

Further, the AQT switch 652 can be coupled to a video-on-demand importer server 658 that receives and stores television or movie content received at the acquisition tier 606 and communicates the stored content to the VOD server 636 at the client-facing tier 602 via the private network 610. Additionally, at the acquisition tier 606, the video-on-demand (VOD) importer server 658 can receive content from one or more VOD sources outside the IPTV system 600, such as movie studios and programmers of non-live content. The VOD importer server 658 can transmit the VOD content to the AQT switch 652, and the AQT switch 652, in turn, can communicate the material to the CFT switch 630 via the private network 610. The VOD content can be stored at one or more servers, such as the VOD server 636.

When users issue requests for VOD content via the set-top box devices 616, 624, the requests can be transmitted over the access network 667 to the VOD server 636, via the CFT switch 630. Upon receiving such requests, the VOD server 636 can retrieve the requested VOD content and transmit the content to the set-top box devices 616,624 across the access network 667, via the CFT switch 630. The set-top box devices 616, 624 can transmit the VOD content to the television monitors 618, 626. In an illustrative embodiment, video or audio portions of VOD content can be streamed to the set-top box devices 616, 624.

FIG. 6 further illustrates that the operations and management tier 608 can include an operations and management tier (OMT) switch 660 that conducts communication between the operations and management tier 608 and the public network 612. In the embodiment illustrated by FIG. 6, the OMT switch 660 is coupled to a TV2 server 662. Additionally, the OMT switch 660 can be coupled to an OSS/BSS server 664 and to a simple network management protocol (SNMP) monitor 686 that monitors network devices within or coupled to the IPTV system 600. In a particular embodiment, the OMT switch 660 can communicate with the AQT switch 652 via the public network 612.

In an illustrative embodiment, the live acquisition server 654 can transmit content to the AQT switch 652, and the AQT switch 652, in turn, can transmit the content to the OMT switch 660 via the public network 612. In this embodiment, the OMT switch 660 can transmit the content to the TV2 server 662 for display to users accessing the user interface at the TV2 server 662. For example, a user can access the TV2 server 662 using a personal computer 668 coupled to the public network 612.

In a particular embodiment, the client facing tier 602 may include a video link server 631. The video link server 631 may receive a request from the set-top box device 624 via the access network 667 to establish a first video link between the set-top box device 624 and a service provider. The video link server 631 may also select a first service provider 613 from at least two service providers, such as service providers 613 and 615. The video link server 631 may establish the first video link over the public network 612. In a particular embodiment, the service provider 613 may be coupled to the private network 610, to the access network 667, or to both the private network 610 and the access network 667.

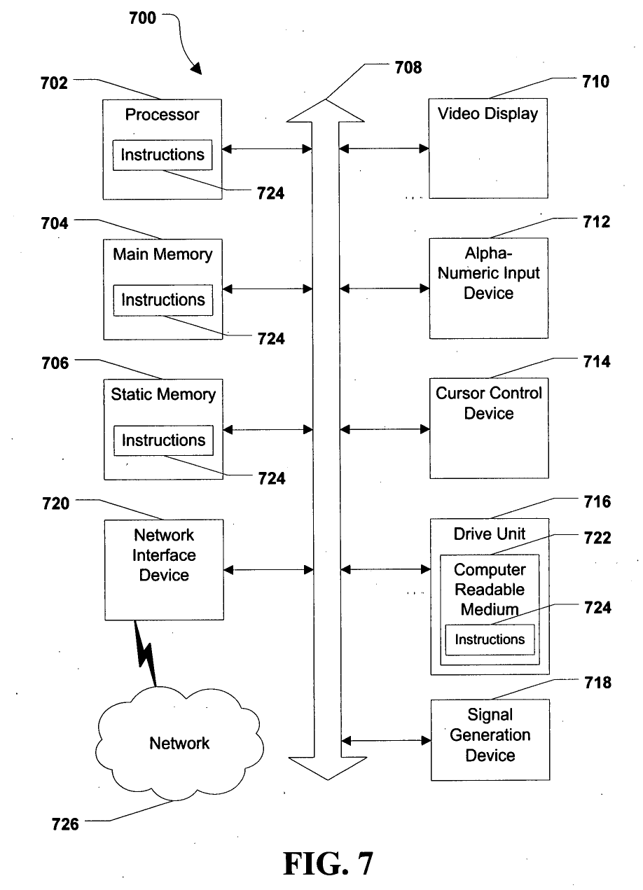

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700, or any portion thereof, may operate as a standalone device or may be connected, e.g., using a network, to other computer systems or peripheral devices, including a server or user device, as shown in FIGS. 1, 2, and 6.

In a networked deployment, the computer system may operate in the capacity of an IPTV server, such as a video server or application server, or a set-top box device. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other re-writable memory, either volatile or non-volatile. Additionally, the computer-readable medium can include a magnetic, a magneto-optical, or an optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving a request to establish a first video link to a healthcare service provider;
selecting a first healthcare service provider from at least two healthcare service providers; and
establishing the first video link to the first healthcare service provider.

2. The method of claim 1, further comprising:
receiving a first video from the first healthcare service provider; and
transmitting the first video to a request device.

3. The method of claim 2 wherein the first video comprises a video from a mobile video device.

4. The method of claim 3 wherein the mobile video device is selected from one of a cellular telephone, a personal digital assistant, a mobile computer, and a video camera.

5. The method of claim 2, wherein the first video link is a two-way video link between the request device and the first healthcare service provider.

6. The method of claim 1, further comprising establishing a second video link to a second healthcare provider while maintaining the first video link.

7. The method of claim 1, wherein the first video link is provided over a network selected from a cellular network, a television broadcast network, and an internet protocol network.

8. The method of claim 2, further comprising:
receiving an instructional healthcare video via the first video link from the first healthcare provider; and
transmitting the instructional healthcare video to the request location via the first video link.

9. The method of claim 2, further comprising:
receiving a first live video stream from the request device; and
transmitting the first live video stream to the first healthcare service provider.

10. The method of claim 1, further comprising:
receiving a first live video stream over the first video link from the first healthcare service provider; and
transmitting the first live video stream over the first video link.

11. The method of claim 10, further comprising:
receiving a second video stream; and
transmitting the second video stream to a request device while maintaining the first live video stream.

12. The method of claim 11, wherein the second video stream is an instructional video.

13. The method of claim 1, further comprising:
receiving first data indicating an availability of a healthcare service; and
selecting the first healthcare service provider at least partially based on the first data.

14. The method of claim 1, further comprising:
receiving first data indicating a proximity of a physician to a request location; and
selecting the first healthcare service provider at least partially based on the first data.

15. The method of claim 1, further comprising:
receiving first data indicating an insurance plan of a person making the request; and
selecting the first healthcare service provider at least partially based on the first data.

16. The method of claim 1, further comprising:
receiving medical history information of a requestor; and
selecting the first healthcare service provider at least partially based on the medical history information.

17. The method of claim 16, wherein the medical history information is received from a database accessible by a website.

18. A device comprising:
a network interface;
a processor coupled to the network interface, the processor operable to execute
a method comprising:
receiving a request to establish a first video link to a first healthcare service provider;
transmitting information related to a selection of a first healthcare service provider from at least two healthcare service providers, the selection at least partially based on the information;
establishing the first video link via the network interface with the first healthcare service provider; and
providing a first video received over the first video link to a display device.

19. The device of claim 18, wherein the information further comprises information including at least one of a service provider identification, an insurance plan, a medical history, a proximity of a service provider, an availability of a service provider, a specialty of a service provider, a location of a service provider, contact information for a service provider, a quality rating of a service provider, an insurance plan identification, a co-pay amount, a deductible amount, an eligible service provider, a coverage type, a maximum coverage amount, an insurance policy holder, a person covered under the insurance policy, a past service, a previous service date, a future service date, an equipment identification, a specific service technician, allergy information, a medical treatment information, a medication information, a payment information, and a problem diagnosis information.

20. The device of claim 18, wherein the processor is operable to execute the method further comprising:
receiving a second video; and
providing the second video to the display device.

21. The device of claim 20, wherein the first video and the second video are provided to the display device for concurrent display.

22. The device of claim 21, wherein the concurrent display comprises one of a picture-in-picture display and a side-by-side display.

23. The device of claim 22, wherein the information comprises a type of medical information requested by a user.

24. A graphical user interface comprising:
a first screen comprising a channel listing including a first channel; and
a first selectable element, wherein a selection of the first selectable element initiates a request to establish a first video link with a first healthcare service provider to provide a first video on the first channel.

25. The graphical user interface of claim 24, further comprising a second screen to allow an input of data, the data to select the healthcare service provider from at least two healthcare service providers.

26. The graphical user interface of claim 25, wherein the data further comprises at least one of verification data, personal identification number data, or text data.

27. A computer-readable medium having instructions to cause a processor to perform a method, the method comprising:
receiving a request to establish a video connection to an emergency service provider over an internet protocol television network; and
initiating the video connection to the emergency service based on the request.

28. The computer-readable medium of claim 27, wherein the method further comprises transmitting information related to a selection of a first emergency service provider from at least two emergency service providers, the selection at least partially based on the information.

29. The computer-readable medium of claim 27, wherein the emergency service provider is one of a healthcare service provider, an ambulance service provider, a police service provider, a security service provider, a first responder service provider, a security service provider, a fire service provider, an emergency room service provider, a live operator service provider, and a poison first aid service provider.

30. The computer-readable medium of claim 27, wherein the request is initiated from a selection of a remote control equipped with an actuator for requesting an emergency service.
